(19) United States
(12) Patent Application Publication
(10) Pub. No.: US 2017/0067677 A1
(43) Pub. Date: Mar. 9, 2017

(54) METHOD AND DEVICE FOR HEAT RECOVERY ON A VAPOUR REFRIGERATION SYSTEM

(71) Applicant: ECOLACTIS, Ahuy (FR)

(72) Inventor: Laurent DECAESTECKER, Ahuy (FR)

(73) Assignee: ECOLACTIS, Ahuy (FR)

(21) Appl. No.: 15/342,986

(22) Filed: Nov. 3, 2016

Related U.S. Application Data
(63) Continuation of application No. 13/386,948, filed on Mar. 12, 2012.

(51) Int. Cl. F25B 49/02; F25B 6/04; A01J 9/04; F25B 29/00

(52) U.S. Cl. CPC F25B 49/027; F25B 29/003; F25B 6/04; A01J 9/04; F25B 2339/047; F25B 2700/21161; F25B 2600/01

(57) ABSTRACT

A method and a device for heat recovery on a vapour compression refrigeration system allowing the produce hot water, includes at least a first piping closed refrigerating circuit in which a refrigerant fluid circulates, a compressor, an evaporator, an expansion valve, a condenser and/or a heat recovery unit including a water inlet and a water outlet respectively connected to a second piping circuit including a circulating pump. At least one physical unit of the refrigerant fluid and/or water of the second piping circuit is determined. When the physical unit is lower than a predetermined threshold, condensing temperature is increased, and when said physical unit is greater than said predetermined threshold, condensing temperature is decreased to a minimum value.

### CROSS REFERENCE TO RELATED APPLICATIONS

This application is a continuation of U.S. application Ser. No. 13/386,948 filed on Jan. 25, 2012, which is a national stage filing under section 371 of International Application No. PCT/EP2009/059685, filed on Jul. 27, 2009, and published in English on Feb. 3, 2011 as WO 2011/012153.

### FIELD OF THE INVENTION

The invention relates in general to a method and a device for heat recovery on a vapour compression system Said method and device will be particularly useful for bulk milk coolers on farms.

### BACKGROUND OF THE INVENTION

In a well known vapour compression refrigeration system including at least a first piping closed refrigerating circuit in which a refrigerant fluid circulates, a compressor, an evaporator, an expansion valve, and a condenser, a refrigerant fluid is entered in a vapour saturated state into the compressor, the refrigerant fluid is compressed to a higher pressure resulting in a higher temperature, in such a way that the refrigerant fluid is in a superheated vapour state, then the refrigerant fluid is cooled and condensed in superheated vapour state into a saturated liquid by passing it through the condenser, then the saturated liquid is passed through the expansion valve to reduce abruptly the pressure providing a flash evaporation that lowers the liquid and vapour refrigerant's temperature, and finally the liquid and vapour refrigerant is passed through the evaporator to extract the heat from a hot source such a tank for example.

Moreover, in many applications, there is a need for refrigeration and/or air conditioning requirement and a need for hot water.

Usually, the refrigeration system is operated totally separate from the hot water system with the result that the heat removed in the condensing process of the refrigeration system is wasted, while the water in the hot water system is heated by means of an external energy source such as electricity.

To overcome this drawback, various devices for heat recovery on a vapour compression refrigeration system allowing producing hot water are already known. Such devices for bulk milk coolers on farms, for example, include usually, referring to FIG. 1, at least a first piping closed refrigerating circuit 1 in which a refrigerant fluid circulates, a compressor 2, a cooling tank 3 comprising an evaporator and an expansion valve, a condenser 4 and a heat recovery unit 5 including a water inlet and a water outlet respectively connected to a second piping circuit 6 comprising a circulating pump 7, a storage tank 8 and an electrical heater 9. It should be noted that the electrical heater 9 can be embedded in the storage tank 8.

For example, the U.S. Pat. No. 4,041,726 has already disclosed a method and a device wherein the water is heated by transferring the superheat, heat of condensation and a part of the liquid refrigerant's sensible heat in a uniquely designed heat exchanger The heated water then circulates by convection, when the water reaches a selected temperature, into a hot water storage tank where the water remains stratified with the hot water at the top of the tank and the colder water at the bottom The tank may fill completely with hot water at the selected temperature.

Nevertheless, even if it allows heat recovery, this method and device has several drawbacks Firstly, the condensing temperature is constantly on a high level thus resulting globally in high electricity consumption and low cooling performance Secondly, the production of hot water is independent from the requirement and the excess heated water is wasted.

Moreover, the German patent application DE3512748 discloses a device for the connection of a refrigeration unit to a heat recovery installation using a thermostat-controlled three-way valve. Said device includes a first piping closed refrigerating circuit in which a refrigerant fluid circulates, a compressor, an evaporator, an expansion valve, an air cooled condenser and a three way-valve connecting said first piping circuit to a heat recovery unit including a water inlet and a water outlet respectively connected to a second piping circuit including a circulating pump and a heat exchanger comprised in a water tank. The condensing temperature is regulated by a thermostatically controlled head of the three-way valve, said thermostatically controlled head being connected to the heat temperature sensor arranged in the hot water tank and/or on the refrigerant circuit piping. The condenser is automatically called upon continuously to a greater or lesser extent for carrying off any excess condensation heat, as soon as an adjustable temperature limit is exceeded at the detector points. The refrigeration compressor of the refrigeration unit is always operated below an upper loading limit. The condensing temperature is always maintained below an upper limit enabling heat recovery.

Nevertheless, even if it allows heat recovery, this method and device has several drawbacks The condensing temperature is constantly maintained below an upper limit necessarily set on a high level to enable heat recovery thus resulting globally in high electricity consumption and low cooling performance The condenser fan is working continuously even when the condenser is by-passed thus resulting in useless electricity consumption This device utilises regulation means that are not standard refrigeration components and requires complex piping installation.

To overcome above-mentioned limitation, a need exists for a method and a device providing an optimized heat recovery and a lower electricity consumption of the refrigeration unit together with higher cooling performances.

### SUMMARY OF THE INVENTION

It is therefore an object of the invention to provide a method for heat recovery on a vapour compression refrigeration system allowing to produce hot water, said refrigeration unit including at least a first piping closed refrigerating circuit in which a refrigerant fluid circulates, a compressor an evaporator, an expansion valve, a condenser, and/or a heat recovery unit including a water inlet and a water outlet respectively connected to a second piping circuit including a circulating pump, said method comprising at least the steps of entering the refrigerant fluid in a vapour saturated state into the compressor, compressing the refrigerant fluid to a higher pressure resulting in a higher temperature, in such a way that the refrigerant fluid is in a superheated vapour state, cooling and condensing the refrigerant fluid in superheated vapour state into a saturated liquid by passing it through the condenser and/or heat recovery unit, passing the saturated liquid through the expansion valve to reduce abruptly the pressure providing a flash evaporation that lowers the liquid and vapour refrigerant's temperature, passing the liquid and vapour refrigerant through the evaporator to extract the heat from a hot source. The method is remarkable in that it comprises at least the following steps of determining at least one physical unit of the refrigerant fluid and/or water of the second piping circuit, and when said physical unit is lower than a predetermined threshold, the condensing temperature is increased, and when said physical unit is greater than said predetermined threshold the condensing temperature is decreased to a minimum value.

The condensing temperature is increased to a level enabling the transfer of the latent heat of condensation to the water i e, if the water is heated to 55 degrees C., the condensing temperature will be in the range of 50 degrees C.

The condensing temperature is decreased to a minimum value enabled by the condenser and its operating conditions, i.e.:
On a system with air cooled condenser, if the ambient temperature is 20 degrees C., the condensing temperature will be in the range of 38 degrees C.
On a system with water cooled condenser, if the water temperature is 12 degrees C., the condensing temperature will be in the range of 25 degrees C.

Said physical unit is the water temperature at the second water piping circuit.

Alternatively, said physical unit is the refrigerant fluid's temperature

In another embodiment, said physical unit is the refrigerant fluid's pressure. Moreover, the threshold is a water temperature at the second piping circuit comprised between 30 and 40 degrees C. and preferably the threshold is a water temperature at the second piping circuit equal to 35 degrees C.

Preferably, when said physical unit is lower than the predetermined threshold, the hot water flow rate at the outlet of the heat recovery unit is regulated in such a manner that the water temperature at its outlet reaches a determined value or in such a manner that the refrigerant fluid temperature/pressure reaches a determined value.

In one embodiment, the condensing temperature is increased by deactivating the condenser.

When said physical unit is greater than said predetermined threshold, the condensing temperature is decreased at a minimum value and the condensing temperature is maintained to a minimum value as a function of at least one parameter even if said physical unit becomes lower than said predetermined threshold.

The condensing temperature is maintained to a minimum value during a predetermined time even if said physical unit becomes lower than said predetermined threshold.

The method further comprises the following steps of measuring refrigerant fluid's pressure between the compressor and the expansion valve, and when said refrigerant fluid's pressure is greater than a predetermined value, the condensing temperature is decreased to a minimum value regardless of whether said physical unit is greater or lower than said predetermined threshold.

Another object of the invention relates to a device for heat recovery on a vapour compression refrigeration system allowing to produce hot water, the refrigeration unit including at least a first piping closed refrigerating circuit in which a refrigerant fluid circulates, a compressor, an evaporator, an expansion valve, a condenser and/or a heat recovery unit including a water inlet and a water outlet respectively connected to a second piping circuit comprising a circulating pump. The device is remarkable in that it comprises at least means for determining at least one physical unit of the refrigerant fluid and/or water of the second piping circuit, means for increasing condensing temperature when said physical unit is lower than a predetermined threshold, and means for decreasing the condensing temperature to a minimum value when said physical unit is greater than said predetermined threshold.

Means for determining said physical unit is a thermostat positioned at the low temperature area of the second piping circuit.

Alternatively, means for determining said physical unit is a thermostat positioned at the first piping circuit between the compressor and the expansion valve.

In another embodiment, means for determining said physical unit is a pressure switch positioned at the first piping circuit between the compressor and the expansion valve.

Moreover, the threshold is a water temperature at the low temperature area of the second piping circuit comprised between 30 and 40 degrees C., and preferably the threshold is a water temperature at the low temperature area of the second piping circuit equal to 35 degrees C.

Preferably, it comprises means for regulating the hot water flow rate at the outlet of the heat recovery unit in such a manner that the water temperature at its outlet reaches a determined value or in such a manner that the refrigerant fluid temperature/pressure reaches a determined value when said physical unit is lower than predetermined threshold.

Furthermore, means for increasing and/or decreasing condensing temperature is a switch for activating/deactivating the condenser.

The device further comprises means for decreasing the condensing temperature to a minimum value when said physical unit is greater than said predetermined threshold and for holding the condensing temperature to a minimum value as a function of at least one parameter even if said physical unit becomes lower than said predetermined threshold.

Said means is a thermostat including a timer unit positioned at the low temperature area of the second piping circuit to maintain the condensing temperature at a minimum value during a predetermined time even if the water temperature becomes lower than said predetermined threshold.

Advantageously, said device further comprises security means including a pressure switch positioned between the compressor and the expansion valve and activating/deactivating the condenser.

Preferably, the second piping circuit comprises a preheated water tank.

In one embodiment, the condenser is an air cooled condenser including motor driven fan(s) connected to means for increasing/decreasing the condensing temperature.

In another embodiment, the condenser is a water cooled condenser including a water inlet and a water outlet respectively connected to a third piping circuit comprising a solenoid valve connected to means for increasing/decreasing the condensing temperature.

Advantageously, the outlet of the third piping circuit feeds at least one drinking trough.

The device may further comprises an additional water condenser including a water inlet and a water outlet respectively connected to a heating piping circuit comprising a circulating pump piloted by the means for increasing/decreasing the condensing temperature and a heat exchanger wherein a thermostat activating/deactivating the condenser is positioned at the low temperature part of the heating piping circuit.

Said heating piping circuit comprises advantageously a buffering hot water tank.

Moreover, the outlet pipe of the second piping circuit comprises a derivative pipe including a solenoid valve connected to the means for increasing/decreasing the condensing temperature and feeding at least one drinking trough and that the incoming pipe of the second piping circuit comprises a by-pass circuit including a pressostatic valve.

Furthermore, the incoming pipe of the second piping circuit may comprise a filter and a by-pass circuit, said by-pass circuit including a second filter and a solenoid valve connected to the pressure switch.

Accessorily, the condenser and/or the heat recovery unit is embedded in the preheated water tank.

Accessorily, the device further comprises a pressure regulating valve between the heat recovery unit and the condenser and a by-pass piping circuit including a solenoid valve piloted by the thermostat.

In another embodiment, if the refrigerant fluid utilised has a low exhaust temperature, it further comprises means for deactivating the circulating pump when said physical unit is greater than said predetermined threshold.

It should be noted that “a refrigerant fluid having a low exhaust temperature” means a refrigerant fluid having an exhaust temperature below 55 degrees C. when the condensing temperature is at its minimal value, i.e., R404A refrigerant fluid, according to the American norm ANSI/ASHRAE 34 published in 2001 “Designation and Safety Classification of Refrigerants”.

### BRIEF DESCRIPTION OF THE DRAWINGS

For a further understanding of the objects and advantages of the present invention, references should be made to the following drawings in conjunction with the accompanying descriptions and operations, wherein

FIG. 1 shows a schematic representation of a device of prior art,

FIG. 2 shows a schematic representation of a first embodiment of the device according to the invention,

FIGS. 3 and 4 show a schematic representation of the first embodiment's operation of the device according to the invention during the heating of the water of the second piping circuit,

FIG. 5 shows a schematic representation of the first embodiment's operation of the device according to the invention when the water has been heated,

FIG. 6 shows a schematic representation of a second embodiment of the device according to the invention,

FIGS. 7 and 8 show a schematic representation of the second embodiment's operation of the device according to the invention during the heating of the water of the second piping circuit,

FIG. 9 shows a schematic representation of the second embodiment's operation of the device according to the invention when the water has been heated,

FIG. 10 shows a schematic representation of a third embodiment of the device according to the invention,

FIGS. 11 and 12 show a schematic representation of the third embodiment's operation of the device according to the invention during the heating of the water of the second piping circuit,

FIG. 13 shows a schematic representation of another embodiment of the device according to the invention,

FIG. 14 shows a schematic representation of yet another embodiment of the device according to the invention.

### DETAILED DESCRIPTION OF EMBODIMENTS

It is emphasized that, in accordance with the standard practice in the industry, various features are not drawn to scale In fact, the dimensions of the various features may be arbitrarily increased or reduced for clarity of discussion. For the purpose of promoting an understanding of the present invention, references are made in the text hereof to embodiments of a device for heat recovery on a vapour compression refrigeration system of a bulk milk cooler. It is nevertheless understood that no limitations to the scope of the invention are thereby intended.

Furthermore, in the embodiments depicted, like reference numerals refer to identical structural elements in the various drawings.

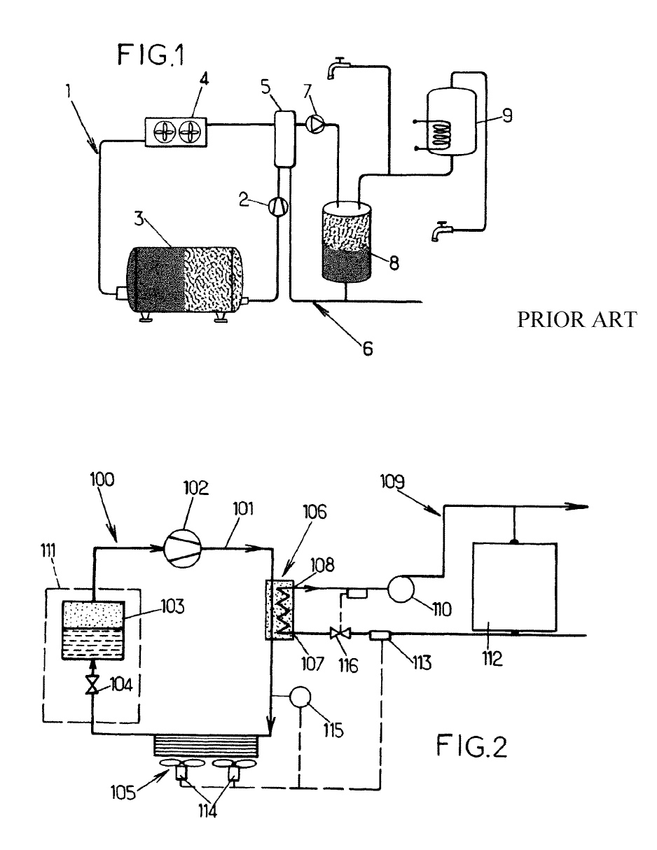

Referring to FIG. 2, the device according to the invention comprises a refrigeration unit 100 including at least a first piping closed refrigerating circuit 101 in which a refrigerant fluid circulates, a compressor 102, an evaporator 103, an expansion valve 104, an air cooled condenser 105 and a heat recovery unit 106 including a water inlet 107 and a water outlet 108 respectively connected to a second piping circuit 109 comprising a circulating pump 110. The evaporator 103 and the expansion valve 104 are embedded in a milk cooling tank 1-11 which is progressively filled up during milking of cows. The hot milk collected in the milk cooling tank 111 is cooled and maintained to a low temperature to avoid any bacterial growth.

Moreover, the second piping circuit 109 comprises a preheated water tank 112 and a thermostat 1-13, preferably including a timer unit, positioned at the low temperature area of the second piping circuit 109, i.e., between the bottom part of the preheated water tank 112 and the inlet of the heat recovery unit 106. The thermostat 113 is connected to the motor driven fans 114 of the air cooled condenser 105 to increase/decrease the condensing temperature as will be described hereinafter.

Accessorily, the device comprises security means including a pressure switch 115 positioned between the compressor 102 and the expansion valve 104. The pressure switch 115 is connected to the motor driven fans 114 of the air cooled condenser 105 in such a manner that the air cooled condenser 105 is activated when the condensing temperature is higher than a security threshold, i.e., the motor driven fans 114 are turned on.

Furthermore, said second piping circuit 109 comprises a thermostatic valve 116 that regulates the water flow in such a manner that its temperature at the water outlet 108 is maintained at a predetermined value.

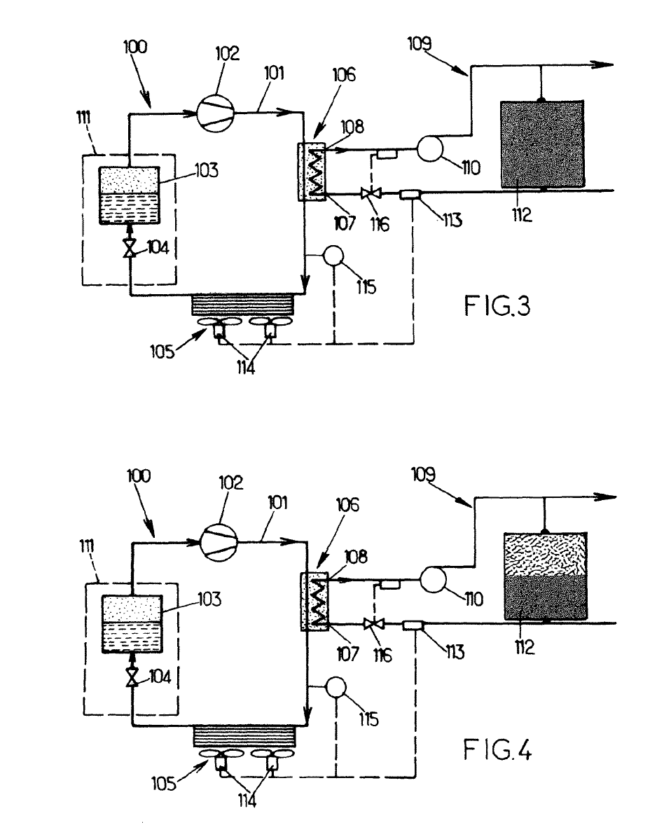

Referring to FIG. 3, the preheated water tank 112 is filled with a cold water, i e the temperature of the water is comprised between 10 degrees C. and 18 degrees C. which is the temperature of the tap water. When the milk cooling tank 111 needs to be cooled, the compressor 102 is activated. The circulating pump 110 provides a circulation of the water in the second piping circuit between the preheated water tank 112 and the heat recovery unit 106. The water temperature in the second piping circuit 109, measured by the thermostat 113, being lower than a predetermined value, 35 degrees C. for example, the air cooled condenser 105 is deactivated by turning off the motor driven fans.

Referring to FIG. 4, the thermostatic valve 116 regulates advantageously the hot water flow rate at the outlet 108 of the heat recovery unit 106 in such a manner that the water temperature at its outlet reaches a determined value. The condensing temperature and the condensing pressure increase and the refrigerant fluid circulating in the first piping circuit 101 transfers its heat to the water of the second piping circuit through the heat recovery unit 106 during the desuperheat phase and its condensing latent heat. It should be noted that by turning off the motor driven fans 114 of the air cooled condenser, the condensing temperature is increased to a high condensing temperature. Nevertheless, if the condensing temperature reaches a security threshold, the pressure switch 115 activates the air cooled condenser 105 by turning on the motor driven fans 114. The activation of the air cooled condenser 105 will decrease the condensing temperature to avoid any deterioration of the refrigeration unit 100. It should be noted that the security threshold will depend on the technical characteristics of the refrigeration unit 100 and the type of refrigerant fluid.

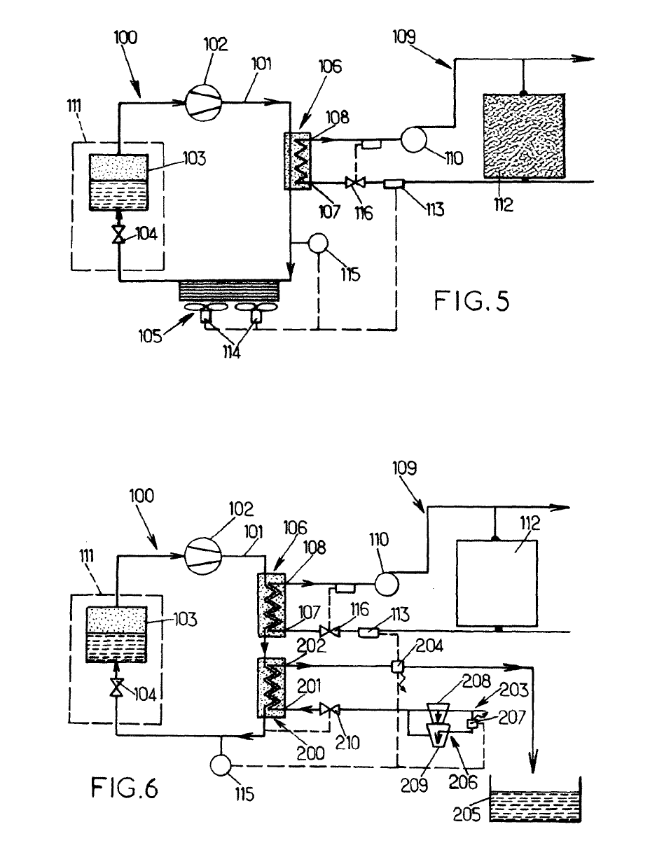

Referring to FIG. 5, when the temperature of the water filled in the preheated water tank 112 does not provide condensation in the heat recovery unit 106, i.e., when the water reaches a temperature equal to the threshold, about 35 degrees C. for example, the thermostat 113 activates the air cooled condenser 105 by turning on the driven motor fans 114. In this way, the condensing temperature decreases to a minimum value increasing the cooling efficiency and decreasing the power consumption. For a refrigerant fluid having a high exhaust temperature, such as refrigerant fluid R22 according to the American norm ANSI/ASHRAE 34 published in 2001 “Designation and Safety Classification of Refrigerants”, the heat recovery unit 106 provides both the desuperheating of gas and the heating of the water in the preheated water tank 112 For a refrigerant fluid having a low exhaust temperature, such as refrigerant fluid R404A according to the American norm ANSI/ASHRAE 34 published in 2001 “Designation and Safety Classification of Refrigerants”, the circulating pump 110 is deactivated because the exhaust temperature of the refrigerant fluid does not allow the heating of the water of the preheated tank 112 anymore. When hot water is drawn off the preheated water tank 112, cold water is introduced in the preheated water tank 112 lowering the water temperature in the second piping circuit 109. Even if, the water temperature is lower than the predetermined threshold, the thermostat 113 will not deactivate the air cooled condenser 105 by turning off the motor driven fans 114 until a predetermined duration.

In a second embodiment, referring to FIG. 6, the device according to the invention comprises a refrigeration unit 100 including at least a first piping closed refrigerating circuit 101 in which a refrigerant fluid circulates, a compressor 102, an evaporator 103, an expansion valve 104 and a heat recovery unit 106 including a water inlet 107 and a water outlet 108 respectively connected to a second piping circuit 109 comprising a circulating pump 1-10. The evaporator 103 and the expansion valve 104 are embedded in a milk cooling tank 111 which is progressively filled up during milking of cows.

This embodiment can be distinguished from the preceding by the fact that the air cooled condenser had been replaced by a water cooled condenser 200 including a water inlet 201 and a water outlet 202 respectively connected to a third piping circuit 203. The third piping circuit 203 comprises a solenoid valve 204 positioned at the outlet pipe of the third piping circuit 203, the outlet of the third piping circuit feeding advantageously at least one drinking trough 205. The inlet pipe of the third piping circuit 203 comprises a by-pass 206 including a solenoid valve 207, each branch of the by-pass comprising a filter 208 and 209, respectively, and a pressostatic valve 210 suitable to regulate the water flow rate in the water condenser maintaining a low condensing temperature while regulating the outlet water temperature as it will be explained hereinafter.

Moreover, the second piping circuit 109 comprises a preheated water tank 112 and a thermostat 113, preferably including a timer unit, positioned at the low temperature area of the second piping circuit 109, i.e., between the bottom part of the preheated water tank 112 and the inlet of the heat recovery unit 106. The thermostat 113 is connected to the solenoid valve 204 of the third piping circuit 203 to increase/decrease the condensing temperature as will be described hereinafter.

Accessorily, the device comprises security means including a pressure switch 115 positioned between the compressor 102 and the expansion valve 104. The pressure switch 115 is connected to the solenoid valve 207 of the by-bass 206 and to the solenoid valve 204 of the third piping circuit 203 in such a manner that the water condenser 200 is activated and the filter 208 is by-passed when the condensing temperature is higher than a security threshold.

Furthermore, said second piping circuit 109 comprises a thermostatic valve 116 that regulates the water flow in such a manner that its temperature at the water outlet 108 is maintained at a predetermined value.

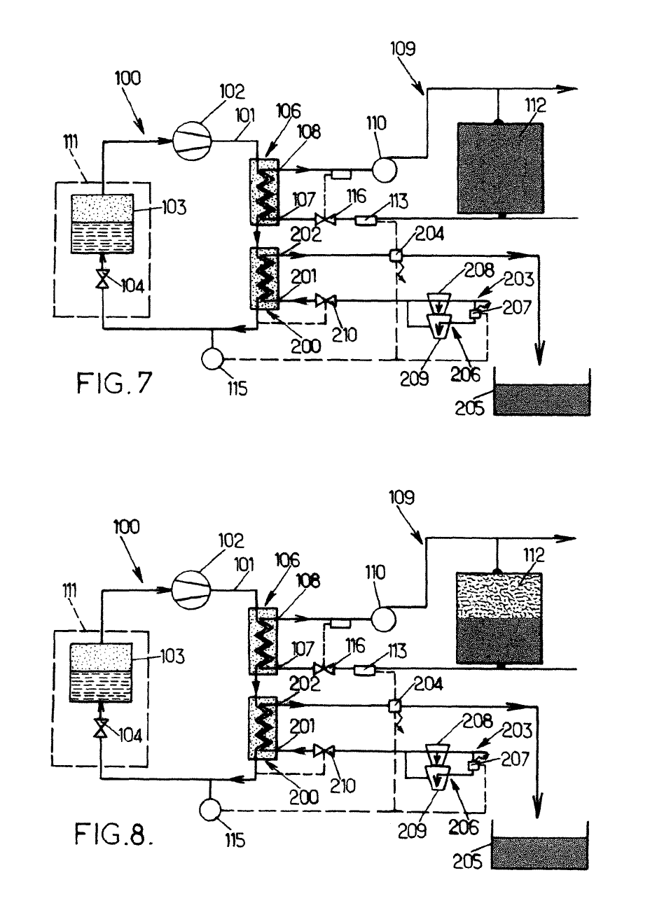

Referring to FIG. 7, the preheated water tank 112 is filled with a cold water, i.e., the temperature of the water is comprised between 10 degrees C. and 18 degrees C. which is the temperature of the tap water. When the milk cooling tank 111 needs to be cooled, the compressor 102 is activated. The circulating pump 110 provides circulation of the water in the second piping circuit 109 between the preheated water tank 112 and the heat recovery unit 106. The water temperature in the second piping circuit 109, measured by the thermostat 113, being lower than a predetermined value, 35 degrees C. for example, the water condenser 200 is deactivated by turning off the solenoid valve 204 of the third piping circuit 203.

Referring to FIG. 8, the thermostatic valve 116 regulates advantageously the hot water flow rate at the outlet 108 of the heat recovery unit 106 in such a manner that the water temperature at its outlet reaches a determined value. The condensing temperature and the condensing pressure increase and the refrigerant fluid circulating in the first piping circuit 101 transfers its heat to the water of the second piping circuit through the heat recovery unit 106 during the desuperheat phase and its condensing latent heat. It should be noted that by turning off the solenoid valve 204, the condensing temperature is increased to a high condensing temperature. Nevertheless, if the condensing temperature reaches a security threshold, the pressure switch 115 turns on the solenoid valve 207 of the by-pass 206 and activates the water condenser 200 by turning on the solenoid valve 204. The activation of the water condenser 200 will decrease the condensing temperature to avoid any deterioration of the refrigeration unit 100 and the type of refrigerant fluid.

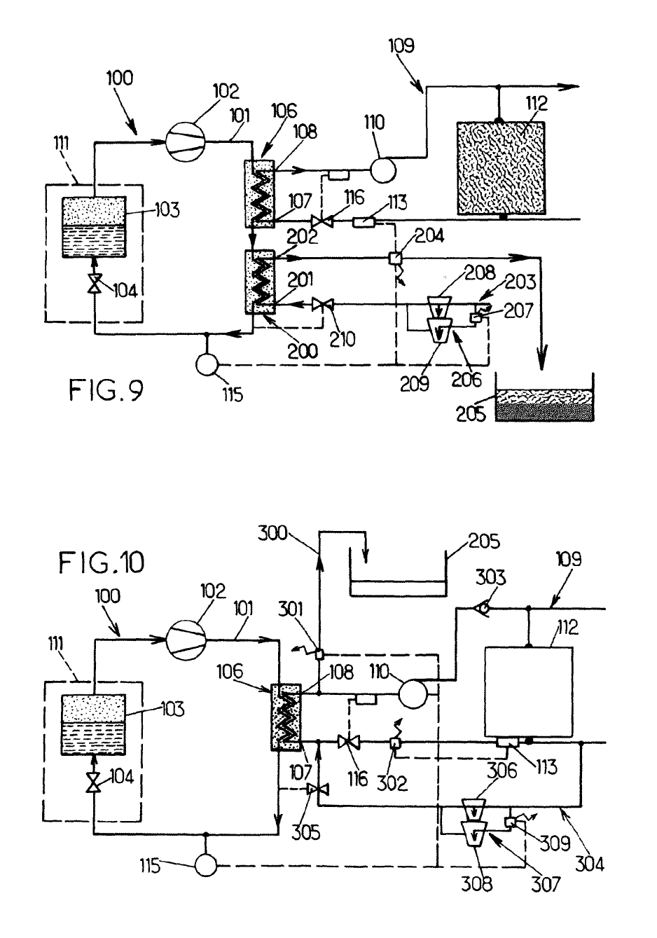

Referring to FIG. 9, when the temperature of the water filled in the preheated water tank 112 does not provide condensation in the heat recovery unit 106, i.e., when the water reaches a temperature equal to the threshold, about 35 degrees C. for example, the thermostat 113 activates the water condenser 200 by turning on the solenoid valve 204 of the third piping circuit 203. In this way, water circulates in the water condenser 200 and the third piping circuit 203 feeds advantageously the drinking trough 205. The pressostatic valve 210 regulates the water flow rate in the water condenser 200 maintaining a low condensing pressure increasing the cooling efficiency and decreasing the power consumption while regulating the water outlet temperature.

For a refrigerant fluid having a high exhaust temperature, such as refrigerant fluid R22 according to the American norm ANSI/ASHRAE 34 published in 2001 “Designation and Safety Classification of Refrigerants”, the heat recovery unit 106 provides both the desuperheating of gas and the heating of the water in the preheated water tank 112. For a refrigerant fluid having a low exhaust temperature, such as refrigerant fluid R404A according to the American norm ANSI/ASHRAE 34 published in 2001 “Designation and Safety Classification of Refrigerants”, the circulating pump 110 is deactivated because the temperature of the refrigerant fluid does not allow the heating of the water of the preheated tank 112 anymore. When hot water is drawn off the preheated water tank 112, cold water is introduced in the preheated water tank 112 lowering the water temperature in the second piping circuit 109. Even if the water temperature is lower than the predetermined threshold, the thermostat 113 will not deactivate the water condenser 200 by turning off the solenoid valve 204 until a predetermined duration.

In a third embodiment, referring to FIG. 10, the device according to the invention comprises, as in the first embodiment, a refrigeration unit 100 including at least a first piping closed refrigerating circuit 101 in which a refrigerant fluid circulates, a compressor 102, an evaporator 103, an expansion valve 104 and a heat recovery unit 106 including a water inlet 107 and a water outlet 108 respectively connected to a second piping circuit 109 comprising a circulating pump 1-10. The evaporator 103 and the expansion valve 104 are embedded in a milk cooling tank 111 which is progressively filled up during milking of cows.

Moreover, the second piping circuit 109 comprises a preheated water tank 112 and a thermostat 1-13, preferably including a timer unit, positioned at the low temperature area of the second piping circuit 109, i.e., between the bottom part of the preheated water tank 112 and the inlet of the heat recovery unit 106.

This embodiment can be distinguished from the first embodiment illustrated in FIG. 2 by the fact that the air cooled condenser had been deleted. The outlet pipe of the second piping circuit 109 comprises a derivative pipe 300 including a solenoid valve 301 connected to the thermostat 113, said thermostat 113 being also connected to a solenoid valve 302 positioned between said thermostat 113 and the thermostatic valve 116. The derivative pipe 300 feeds at least one drinking trough 205 and the incoming pipe of the second piping circuit 109 comprises a by-pass circuit 304 including a pressostatic valve 305. Additionally, the outlet pipe of the second piping circuit 109 may comprise a non return valve 303 positioned between the circulating pump 110 and the preheated water tank 112. The incoming pipe of the second piping circuit 109 comprises a filter 306 and a by-pass circuit 307, said by-pass circuit 307 including a second filter 308 and a solenoid valve 309.

Accessorily, the device comprises security means including a pressure switch 115 positioned between the compressor 102 and the expansion valve 104. Said pressure switch 115 is connected to the solenoid valve 309 of the by-bass circuit 307 and to the solenoid valves 301 and 302 of the derivative pipe 300 and respectively the second piping circuit 109.

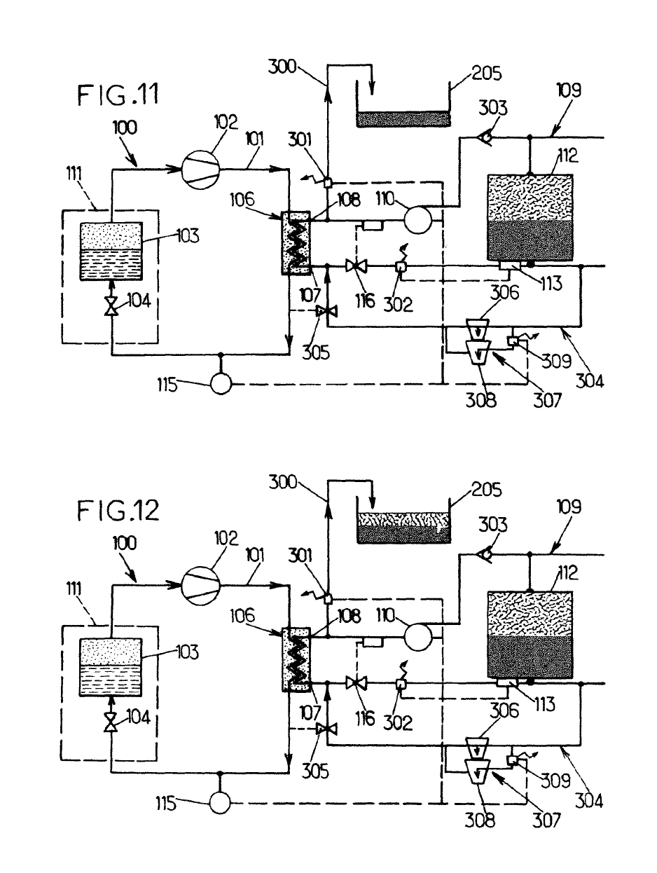

Referring to FIG. 11, the preheated water tank 112 is filled with cold water, i.e., the temperature of the water is comprised between 10 degrees C. and 18 degrees C. which is the temperature of the tap water. When the milk cooling tank 111 needs to be cooled, the compressor 102 is activated. The circulating pump 110 provides circulation of the water in the second piping circuit 109 between the preheated water tank 112 and the heat recovery unit 106. The thermostatic valve 116 regulates advantageously the hot water flow rate at the outlet 108 of the heat recovery unit 106 in such a manner that the water temperature at its outlet reaches a determined value. The condensing temperature and the condensing pressure increase and the refrigerant fluid circulating in the first piping circuit 101 transfers its heat to the water of the second piping circuit through the heat recovery unit 106 during the desuperheat phase and its condensing latent heat.

Referring to FIG. 12, when the temperature of the water filled in the preheated water tank 112 does not provide condensation in the heat recovery unit 106, i.e., when the water reaches a temperature equal to the threshold, about 35 degrees C. for example, the thermostat 113 turns off the solenoid valve 302 to close the second piping circuit 109 and turns on the solenoid valve 301 of the derivative pipe 300. In the same time, the circulating pump 110 connected to the thermostat 113 is stopped. Consequently, the water circulates in the heat recovery unit 106 which heats said water while condensing the refrigerant fluid. The hot water feeds the drinking trough 205. The pressostatic valve 210 regulates the water flow rate in the heat recovery unit 106 maintaining a low condensing pressure increasing the cooling efficiency and decreasing the power consumption while regulating the water outlet temperature.

When hot water is drawn off the preheated water tank 112, cold water is introduced in the preheated water tank 112 lowering the water temperature in the second piping circuit 109. Even if the water temperature is lower than the predetermined threshold, the thermostat 113 will not activate and/or deactivate the solenoid valves 301 and 302 until a predetermined duration.

In a fourth embodiment, referring to FIG. 13, the device according to the invention comprises, as in the second embodiment depicted on FIG. 6, a refrigeration unit 100 including at least a first piping closed refrigerating circuit 101 in which a refrigerant fluid circulates, a compressor 102, an evaporator 103, an expansion valve 104 and a heat recovery unit 106 including a water inlet 107 and a water outlet 108 respectively connected to a second piping circuit 109 comprising a circulating pump 110. The evaporator 103 and the expansion valve 104 are embedded in a milk cooling tank 111 which is progressively filled up during milking of cows. The device comprises also a water condenser 200 including a water inlet 201 and a water outlet 202 respectively connected to a third piping circuit 203. Said third piping circuit 203 comprises a solenoid valve 204 positioned at the outlet pipe of the third piping circuit 203, the outlet of the third piping circuit feeding advantageously at least one drinking trough 205. The inlet pipe of the third piping circuit 203 comprises a pressostatic valve 210 suitable to regulate the water flow rate in the water condenser.

Furthermore, said second piping circuit 109 comprises a thermostatic valve 116 that regulates the water flow in such a manner that its temperature at the water outlet 108 is maintained at a predetermined value.

Moreover, the second piping circuit 109 comprises a preheated water tank 112 and a thermostat 113, preferably including a timer unit, positioned at the low temperature area of the second piping circuit 109, i e between the bottom part of the preheated water tank 112 and the inlet of the heat recovery unit 106.

This embodiment comprises a second water condenser 400 including a water inlet 401 and a water outlet 402 respectively connected to a fourth piping circuit 403 called a heating piping circuit. Said heating piping circuit 403 comprises a circulating pump 404 positioned at the outlet pipe of the fourth piping circuit 403, the outlet of the third piping circuit feeding advantageously heating system 405. Said heating piping circuit 403 comprises a thermostatic valve 406 suitable to regulate the water flow rate in the second water condenser 400. Moreover, the heating piping circuit 403 comprises a buffering hot water tank 407 and a second thermostat 408, preferably including a timer unit, positioned at the low temperature area of the fourth piping circuit 403, i.e., between the bottom part of the buffering hot water tank 407 and the inlet 401 of the water condenser 400. The second thermostat 408 is connected to the solenoid valve 204 of the third piping circuit 203 and the first thermostat 113 of the second piping circuit 109 is connected to the circulating pump 404 of the heating piping circuit 403 to pilot it.

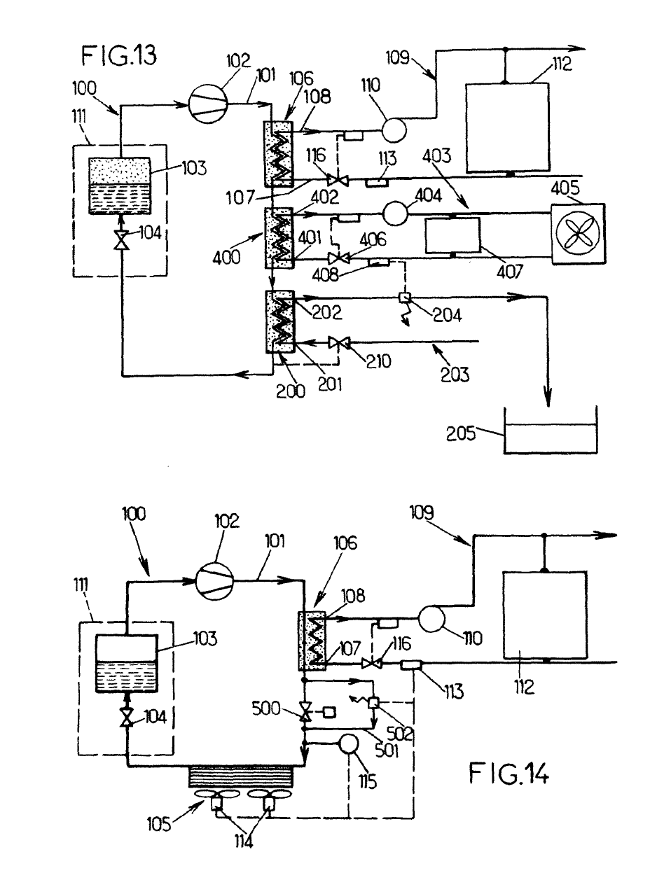

In a last embodiment, referring to FIG. 14, the device according to the invention comprises, as in the first embodiment of FIG. 2, a refrigeration unit 100 including at least a first piping closed refrigerating circuit 101 in which a refrigerant fluid circulates, a compressor 102, an evaporator 103, an expansion valve 104, an air cooled condenser 105 and a heat recovery unit 106 including a water inlet 107 and a water outlet 108 respectively connected to a second piping circuit 109 comprising a circulating pump 110. The evaporator 103 and the expansion valve 104 are embedded in a milk cooling tank 111 which is progressively filled up during milking of cows. The hot milk collected in the milk cooling tank 1-11 is cooled and maintained at a low temperature to avoid any bacterial growth.

Moreover, the second piping circuit 109 comprises a preheated water tank 112 and a thermostat 113, preferably including a timer unit, positioned at the low temperature area of the second piping circuit 109, i.e., between the bottom part of the preheated water tank 112 and the inlet of the heat recovery unit 106. Said thermostat 113 is connected to the motor driven fans 114 of the air cooled condenser 105 to increase/decrease the condensing temperature.

Accessorily, the device comprises security means including a pressure switch 115 positioned between the compressor 102 and the expansion valve 104. Said pressure switch 115 is connected to the motor driven fans 114 of the air cooled condenser 105 in such a manner that the air cooled condenser 105 is activated when the condensing temperature is higher than a security threshold, i.e., the motor driven fans 114 are turned on.

Furthermore, said second piping circuit 109 comprises a thermostatic valve 116 that regulates the water flow in such a manner that its temperature at the water outlet 108 is maintained at a predetermined value.

Additionally, the device comprises a pressure regulating valve 500 between the heat recovery unit 106 and the air cooled condenser 105 and a by-pass piping circuit 501 including a solenoid valve 502 piloted by the thermostat 113.

Additional modifications and improvements of the present invention may also be apparent to those of ordinary skill in the art. For example, the thermostat 113 of any embodiment of the present invention may be substituted by a pressure switch positioned at the first piping circuit between the compressor and expansion valve. Thus, the particular combination of parts described and illustrated herein is intended to represent only certain embodiments of the present invention, and is not intended to serve as limitations of alternative devices within the spirit and scope of the invention.

1.-16. (canceled)

17. A method for heat recovery on a vapour compression refrigeration system allowing to produce hot water, said refrigeration system including at least a first piping closed refrigerating circuit in which a refrigerant fluid circulates, a compressor, an evaporator, an expansion valve, a condenser and a heat recovery unit including a water inlet and a water outlet respectively connected to a second piping circuit including a circulating pump and a preheated water tank, said method comprising at least the steps of entering the refrigerant fluid in a vapour saturated state into the compressor, compressing the refrigerant fluid to a higher pressure resulting in a higher temperature, in such a way that the refrigerant fluid is in a superheated vapour state, cooling and condensing the refrigerant fluid in superheated vapour state into a saturated liquid by passing the fluid in superheated vapour state through the condenser and/or heat recovery unit, passing the saturated liquid through the expansion valve to reduce abruptly pressure providing a flash evaporation that lowers temperature of the refrigerant's fluid, passing the refrigerant fluid through the evaporator to extract heat from a hot source, said method further comprising at least the following steps of:
determining at least one physical unit of the refrigerant fluid and/or water of the second piping circuit,
predetermining a threshold corresponding to a value of the at least one physical unit when water filled in the water tank does not provide condensation in the heat recovery unit,
when said at least one physical unit is lower than the predetermined threshold, increasing condensing temperature and decreasing cooling capacity in such a manner that the refrigerant fluid circulating in the first piping circuit transfers its heat to water of the second piping circuit through the heat recovery unit during a desuperheat phase and its condensing latent heat in order to optimize heat recovery performance, and
when said at least one physical unit is greater than said predetermined threshold, decreasing the condensing temperature to a minimum value dictated by type of the condenser and ambient temperature, and decreasing heat recovery capacity in such a manner that the refrigerant fluid circulating in the first piping circuit transfers its heat to the water of the second piping circuit through the heat recovery unit during the desuperheat phase in order to maximize cooling performance.

18. The method of claim 17, further including, when said at least one physical unit is lower than the predetermined threshold, regulating hot water flow rate at the water outlet of the heat recovery unit in such a manner that water temperature at said outlet reaches a determined value.

19. The method of claim 17, wherein said at least one physical unit comprises water temperature at the second piping circuit.

20. The method of claim 17, wherein said at least one physical unit comprises pressure of the refrigerant fluid.

21. The method of claim 17, wherein the predetermined threshold is a water temperature at the second piping circuit between 30 and 40 degrees C.

22. The method of claim 17, wherein the condensing temperature is increased by deactivating the condenser.

23. The method of claim 17, wherein when said at least one physical unit is greater than said predetermined threshold and the condensing temperature is decreased to a minimum value, the condensing temperature is maintained at the minimum value as a function of at least one parameter even if said at least one physical unit becomes lower than said predetermined threshold.

24. A device for heat recovery on a vapour compression refrigeration system allowing to produce hot water, said refrigeration unit including at least a first piping closed refrigerating circuit in which a refrigerant fluid circulates, a compressor, an evaporator, an expansion valve, a condenser and a heat recovery unit including a water inlet and a water outlet respectively connected to a second piping circuit comprising a circulating pump and a preheated water tank, said device further comprising at least a thermostat positioned at a low temperature area of the second piping circuit or at the first piping circuit between the compressor and expansion valve for determining at least one physical unit of the refrigerant fluid and/or water of the second piping circuit and a switch for activating the condenser/deactivating the condenser;
wherein the switch deactivates the condenser, when said at least one physical unit of the refrigerant fluid and/or water of the second piping circuit is lower than a predetermined threshold corresponding to a value of the physical unit when temperature of water filled in the water tank does not provide condensation in the heat recovery unit, for increasing condensing temperature in such a manner that the refrigerant fluid circulating in the first circuit transfers its heat to the water of the second piping circuit though the heat recovery unit during a desuperheat phase and its condensing latent heat in order to optimize heat recovery performance when the at least one physical unit is lower than the predetermined threshold; and
wherein the switch activates the condenser for decreasing the condensing temperature to a minimum value dictated by type of the condenser and ambient temperature, and decreasing heat recovery capacity when said physical unit is greater than said predetermined threshold in such a manner that the refrigerant fluid circulating in the first piping circuit transfers its heat to the water of the second piping circuit through the heat recovery unit during the desuperheat phase in order to maximize cooling performance.

25. The device of claim 24, further comprising a thermostatic valve for regulating hot water flow rate at the water outlet of the heat recovery unit in such a manner that water temperature at said outlet reaches a determined value when said at least one physical unit is lower than the predetermined threshold.

26. The device of claim 24, wherein the predetermined threshold comprises a water temperature at a low temperature area of the second piping circuit between 30 and 40 degrees C.

27. The device of claim 24, wherein the thermostat positioned at a low temperature area of the second piping circuit includes a timer unit to maintain the condensing temperature at the minimum value during a predetermined time even if temperature of the water becomes lower than said predetermined threshold.

28. The device of claim 24, further comprising a pressure regulating valve between the heat recovery unit and the condenser, and a by-pass piping circuit including a solenoid valve piloted by the thermostat.

29. The device of claim 26, wherein the predetermined threshold comprises a water temperature at the low temperature area of the second piping circuit equal to 35° C.

30. The device of claim 24, further comprising security means including a pressure switch positioned between the compressor and the expansion valve and the switch for activating the condensor/deactivating the condenser.

31. The device of claim 24, wherein the condenser comprises an air cooled condenser including motor driven fan(s) connected to the switch for activating the condenser/deactivating said condenser.

32. The device of claim 24, wherein the condenser comprises a water cooled condenser including a water inlet and a water outlet respectively connected to a third piping circuit comprising a solenoid valve connected to the switch for increasing/decreasing the condensing temperature.

33. The device of claim 32, wherein an outlet of the third piping circuit feeds at least one drinking trough.

34. The device of claim 24, further comprising an additional water condenser including a water inlet and a water outlet respectively connected to a heating piping circuit comprising a circulating pump piloted by the switch for increasing/decreasing the condensing temperature, a heat exchanger wherein a thermostat activating/deactivating the condenser is positioned at a low temperature part of the heating piping circuit.

35. The device of claim 34, wherein the heating piping circuit comprises a buffering hot water tank.

36. The device of claim 24, wherein an outlet pipe of a second piping circuit comprises a filter and a by-pass circuit, said by-pass circuit including a second filter and a solenoid valve connected to the pressure switch.

37. The device of claim 24, wherein an incoming pipe of a second piping circuit comprises a filter and a by-pass circuit, said by-pass circuit including a second filter and a solenoid valve connected to the pressure switch.

38. A device for heat recovery on a vapour compression refrigeration system allowing to produce hot water, said refrigeration system including at least a first piping closed refrigerating circuit in which a refrigerant fluid circulates, a compressor, an evaporator, an expansion valve, a condenser and a heat recovery unit including a water inlet and a water outlet respectively connected to a second piping circuit comprising a circulating pump and a preheated water tank, said device further comprising at least a pressure switch positioned at the first piping circuit between the compressor and the expansion valve for determining at least one physical unit of the refrigerant fluid and/or water of the second piping circuit and a switch for activating the condenser/deactivating the condenser;
wherein the switch deactivates the condenser when said at least one physical unit of the refrigerant fluid and/or the water of the second piping circuit is lower than a predetermined threshold corresponding to a value of the physical unit when temperature of water filled in the water tank does not provide condensation in the heat recovery unit, for increasing temperature in such a manner that the refrigerant fluid circulating in the first piping circuit transfers its heat to the water of the second piping circuit through the heat recovery unit during a desuperheat phase and its condensing latent heat in order to optimize heat recovery performance when said at least one physical unit is lower than the predetermined threshold; and
wherein the switch activates the condenser for decreasing the condensing temperature to a minimum value dictated by type of the condenser and ambient temperature when said physical unit is greater than said predetermined threshold in such a manner that the refrigerant fluid circulating in the first piping circuit transfers its heat to the water of the second piping circuit through the heat recovery unit during the desuperheat phase in order to maximize cooling performance.

39. The device of claim 38, further comprising a thermostatic valve for regulating hot water flow rate at the water outlet of the heat recovery unit in such a manner that water temperature at said outlet reaches a determined value when said at least one physical unit is lower than the predetermined threshold.

40. The device of claim 38, wherein the predetermined threshold comprises a water temperature at a low temperature area of the second piping circuit between 30 and 40 degrees C.

41. The device of claim 38, further comprising a thermostat including a timer unit positioned at a low temperature area of the second piping circuit to maintain the condensing temperature at the minimum value during a predetermined time even if temperature of the water becomes lower than said predetermined threshold.

42. The device of claim 41, wherein the predetermined threshold comprises a water temperature at the low temperature area of the second piping circuit equal to 35° C.

43. The device of claim 38, further comprising security means including the pressure switch positioned between the compressor and the expansion valve and the switch for activating the condenser/deactivating the condenser.

44. The device of claim 38, wherein the condenser comprises an air cooled condenser including motor drive fan(s) connected to the switch for activating the condenser/deactivating said condenser.

45. The device of claim 38, wherein the condenser comprises a water cooled condenser including a water inlet and a water outlet respectively connected to a third piping circuit comprising a solenoid valve connected to the switch for increasing/decreasing the condensing temperature.

46. The device of claim 45, wherein an outlet of the third piping circuit fees at least one drinking trough.

47. The device of claim 38, further comprising an additional water condenser including a water inlet and a water outlet respectively connected to a heating piping circuit comprising a circulating pump piloted by the switch for increasing/decreasing the condensing temperature, and a heat exchanger, and wherein a thermostat activating/deactivating the condenser is positioned at a low temperature part of the heating piping circuit.

48. The device of claim 47, wherein the heating piping circuit comprises a buffering hot water tank.

49. The device of claim 38, wherein an outlet pipe of the second piping circuit comprises a derivative pipe including a solenoid valve connected to the switch for increasing/decreasing the condensing temperature and feeding at least one drinking trough and wherein an incoming pipe of the second piping circuit comprises a bypass circuit including a pressostatic valve.

50. The device of claim 49, wherein the incoming pipe of the second piping circuit comprises a filter and a by-pass circuit, said by-pass circuit including a second filter and a solenoid valve connected to the pressure switch.

51. The device of claim 38, wherein the refrigerant fluid has an exhaust temperature below 55 degrees C. when the condensing temperature is at a minimal value and further comprising means for deactivating the circulating pump when said at least one physical unit is greater than said predetermined threshold.
